(19) United States
(12) Patent Application Publication
(10) Pub. No.: US 2013/0038071 A1
(43) Pub. Date: Feb. 14, 2013

(54) POWER GENERATOR

(71) Applicants: Toyohiro Kano, Chiryu-city (JP); Takashi Kaneko, Nagoya-city (JP); Shuzo Oda, Kariya-city (JP); Kazutoshi Nishizawa, Toyoake-city (JP)

(72) Inventors: Toyohiro Kano, Chiryu-city (JP); Takashi Kaneko, Nagoya-city (JP); Shuzo Oda, Kariya-city (JP); Kazutoshi Nishizawa, Toyoake-city (JP)

(73) Assignee: DENSO CORPORATION, Kariya-city (JP)

(21) Appl. No.: 13/567,325

(22) Filed: Aug. 6, 2012

(30) Foreign Application Priority Data
Aug. 8, 2011 (JP) 2011-173004

(51) Int. Cl. G01J 5/02

(52) U.S. Cl. 290/1 R

(57) ABSTRACT

A power generator for taking out electric power from a pyroelectric part by changing temperature of the pyroelectric part exhibiting a pyroelectric effect is disclosed. The power generator includes a heating section that heats the pyroelectric part using a heating medium; a cooling section that cools the pyroelectric part using a cooling medium; and a thermal resistance changer that changes at least one of thermal resistance between the heating medium and the pyroelectric part and thermal resistance between the cooling medium and the pyroelectric part.

### CROSS REFERENCE TO RELATED APPLICATION

The present application is based on and claims priority to Japanese Patent Application No. 2011-173004 filed on Aug. 8, 2011, disclosure of which is incorporated herein by reference.

### TECHNICAL FIELD

The present disclosure relates to a power generator utilizing a pyroelectric effect.

### BACKGROUND

A power generator utilizing a pyroelectric effect is disclosed in JP 1999-332266A. The power generator includes a drum-like rotor, a pyroelectric element attached to an outer peripheral surface of the rotor, a heating tank used to raise the temperature of the pyroelectric element, and a cooling tank used to lower the temperature of the pyroelectric element.

The heating tank has a heating medium of a relatively high temperature introduced therein and the cooling tank has a cooling medium of a relatively low temperature introduced therein. The rotation shaft of the rotor is supported by a heat insulating plate partitioning the heating tank and the cooling tank. One half of the outer peripheral surface of the rotor is positioned in the heating tank and the other half is positioned in the cooling tank.

As the rotor rotates, the pyroelectric element moves from the cooling tank to the heating tank and generates electric power by being heated by the heating tank. The pyroelectric element then moves from the heating tank to the cooling tank and is cooled by the cooling tank, and thereafter, the pyroelectric element moves from the cooling tank to the heating tank again and generates electric power by being heated.

According to the above technique, however, as the rotor rotates, the pyroelectric element moves back and forth between the heating tank and the cooling tank, so that the cooling medium in the cooling tank and the heating medium in the heating tank highly likely mix. This lowers the efficiency of heating and cooling the pyroelectric element and results in lowering the efficiency of power generation.

### SUMMARY

In view of the foregoing, it is an object of the present disclosure to provide a power generator utilizing a pyroelectric effect that can minimize mixing of a heating medium and a cooling medium.

According to one example, a power generator for taking out electric power from a pyroelectric part by changing temperature of the pyroelectric part exhibiting a pyroelectric effect is provided. The power generator includes: a heating section that heats the pyroelectric part using a heating medium; a cooling section that cools the pyroelectric part using a cooling medium; and a thermal resistance changer that changes at least one of thermal resistance between the heating medium and the pyroelectric part and thermal resistance between the cooling medium and the pyroelectric part.

According to the above power generator, since at least one of the thermal resistance between the heating medium in the heating section and the pyroelectric part and the thermal resistance between the cooling medium in the cooling section and the pyroelectric part is changed, the temperature of the pyroelectric part can be changed without requiring the pyroelectric part to move back and forth between the heating section and the cooling section. Therefore, it is possible to prevent mixing of the heating medium and the cooling medium.

### BRIEF DESCRIPTION OF THE OF DRAWINGS

The above and other objects, features and advantages of the present disclosure will become more apparent from the following detailed description made with reference to the accompanying drawings. In the drawings:

FIG. 1 is a diagram illustrating a hybrid car mounted with a power generator of a first embodiment;

FIG. 2 is a sectional view illustrating the power generator of the first embodiment;

FIG. 3A is a sectional view illustrating the power generator taken along line IIIA-IIIA in FIG. 2;

FIG. 3B is a sectional view illustrating the power generator taken along line IIIB-IIIIB in FIG. 2;

FIG. 4 is a diagram illustrating an operation of the power generator according to the first embodiment;

FIGS. 5A and 5B are diagrams illustrating a cooled state and a heated state of a pyroelectric part according to the first embodiment;

FIGS. 6A to 6C are diagrams illustrating a principle of pyroelectric power generation;

FIG. 7 is a time chart illustrating an exemplary operation of a power generator according to a second embodiment;

FIG. 8 is a flowchart illustrating a control operation of the power generator according to the second embodiment.

FIG. 9 is a sectional view illustrating a power generator according to a third embodiment.

FIG. 10A is a sectional view illustrating a power generator taken along line

FIG. 10B is a sectional view illustrating a power generator taken along line XB-XB in FIG. 9;

FIG. 10C is a diagram illustrating magnetic coupling;

FIG. 11 is a sectional view illustrating a power generator according to a fourth embodiment.

FIG. 12A is a sectional view illustrating a power generator taken along line XIIA-XIIA in FIG. 11;

FIG. 12B is a sectional view illustrating a power generator taken along line XIIB-XIIB in FIG. 11;

FIG. 13 is a sectional view illustrating a power generator according to a fifth embodiment.

FIG. 14A is a sectional view illustrating a power generator taken along line XIVA-XIVA in FIG. 13;

FIG. 14B is a sectional view illustrating a power generator taken along line XIVB-XIVB in FIG. 13;

FIG. 15 is a sectional view illustrating a power generator according to a sixth embodiment.

FIG. 16A is a sectional view illustrating a power generator taken along line XVIA-XVIA in FIG. 15;

FIG. 16B is a sectional view illustrating a power generator taken along line XVIB-XVIB, in FIG. 15;

FIG. 17 is a sectional view illustrating a power generator according to a seventh embodiment;

FIG. 18A is a sectional view illustrating a power generator taken along line XVIIIA-XVIIIA in FIG. 17;

FIG. 18B is a sectional view illustrating a power generator taken along line XVIIIB-XVIIIB in FIG. 17;

FIG. 19 is a schematic diagram illustrating a power generator according to an eighth embodiment;

FIGS. 20A and 20B are diagrams illustrating an arrangement of pyroelectric parts in FIG. 19;

FIGS. 21A and 21B are diagrams illustrating an arrangement of cooling-side heat switches in FIG. 19;

FIG. 22 is a diagram illustrating an operation of a power generator according to the eighth embodiment;

FIGS. 23A to 23C are diagrams illustrating a power generator according to a ninth embodiment;

FIGS. 24A to 24C are diagrams illustrating a power generator according to a tenth embodiment;

FIGS. 25A to 25C are diagrams illustrating a power generator according to an eleventh embodiment; and

FIGS. 26A and 26B are diagrams illustrating an operation of a power generator according to a twelfth embodiment.

### DETAILED DESCRIPTION

### First Embodiment

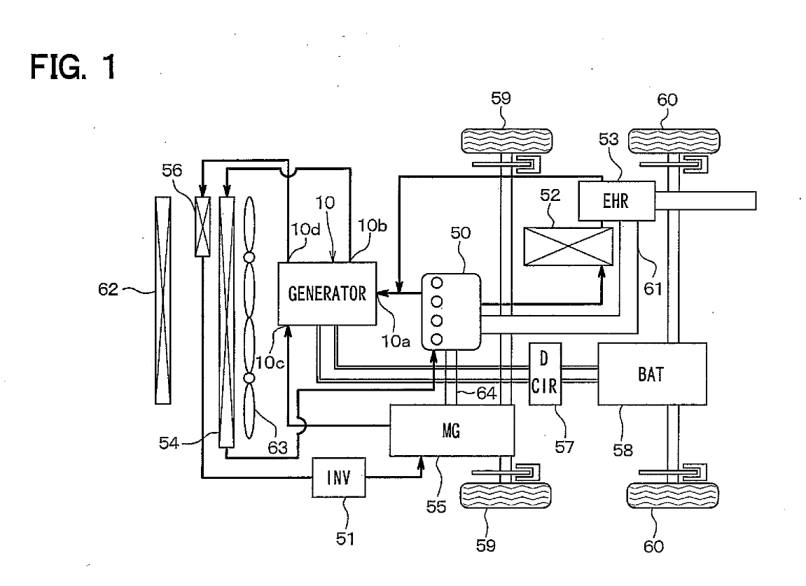

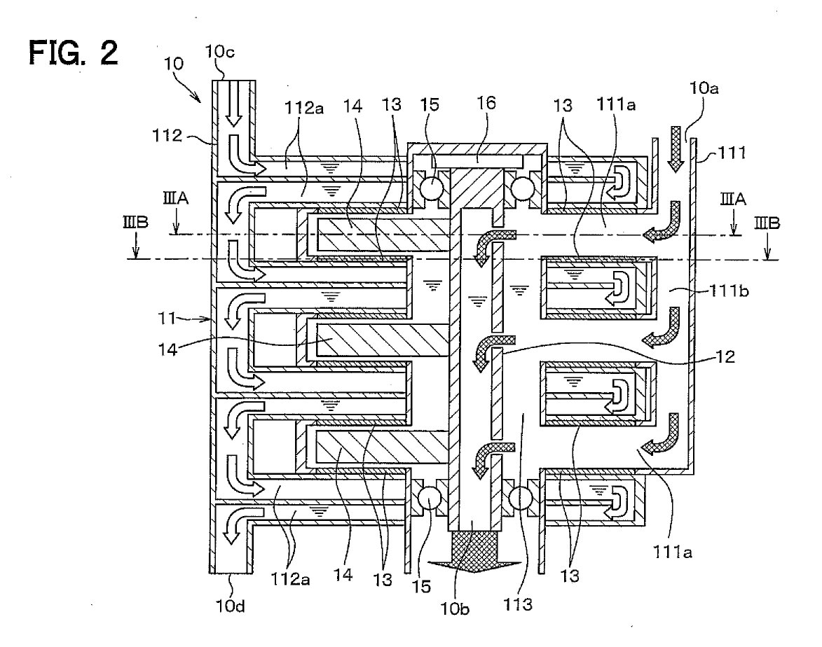

A power generator according to a first embodiment will be described below. In this embodiment, the power generator is mounted on a hybrid car. FIG. 1 is a diagram schematically illustrating a hybrid car mounted with the power generator. FIG. 2 is a schematic sectional view of the power generator.

A power generator 10 obtains electric power from a pyroefectric part, which exhibits a pyroelectric effect, by changing the temperature of the pyroelectric part. To change the temperature of the pyroelectric part, a heating medium with a relatively high temperature and a cooling medium with a relatively low temperature are used.

In the present embodiment, the power generator 10 is provided in the engine room of a vehicle and uses the engine cooling water (of about 90° C.) flowing out from an engine 50 as the heating medium and the inverter cooling water (of about 50° C.) flowing out from an inverter 51 as the cooling medium.

The engine cooling water flowing out from the engine 50 flows into a heating medium inlet 10a of the power generator 10 and, after being used as the heating medium for the power generator 10, flows out from a heating medium outlet 10b.

In the example in FIG. 1, a part of the engine cooling water flowing out from the engine 50 flows into the heating medium inlet 10a of the power generator 10 after passing a heater core 52 (heat exchanger for heating) and an exhaust heat recovering unit (EHR) 53.

After flowing out from the heating medium outlet 10b of the power generator 10, the engine cooling water passes a radiator 54 and returns to the engine 50.

The inverter cooling water flowing out from the inverter 51 passes a motor generator (MG). 55 for traveling, and flows into a cooling medium inlet 10c of the power generator 10 and is used therein as a cooling medium for the power generator 10. Thereafter, the inverter cooling water flows out from a cooling medium outlet 10d of the power generator 10. After flowing out from the cooling medium outlet 10d, the inverter cooling water passes an HV radiator 56 and returns to the inverter 51.

The electric power outputted from the power generator 10 is supplied to a battery 58 via a drive circuit 57.

Other parts of the vehicle such as front wheels 59, rear wheels 60, an exhaust pipe 61, a condenser 62, a blowing fan 63 and a transaxle 64 are also illustrated in FIG. 1.

The condenser 62 acts as a heat exchanger for condensing a coolant of the refrigeration cycle of an air conditioner for the vehicle. The blowing fan 63 includes an electric fan for sending air to the radiator 54, the HV radiator 56 and the fan 63. The transaxle 64 is connected to the output shaft of the engine 50 and the output shaft of the motor generator for driving 55.

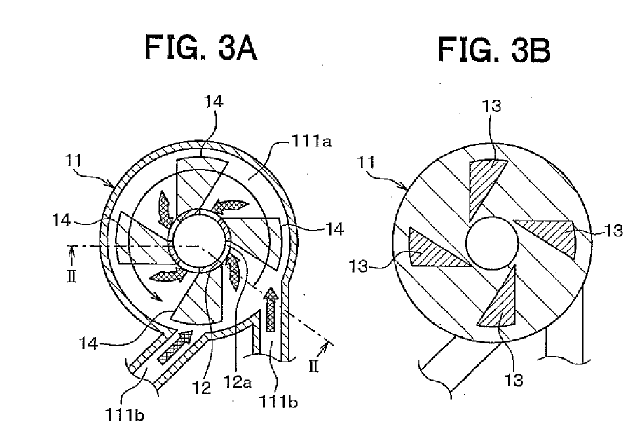

FIG. 2 is a sectional view of the power generator 10 illustrated in FIG. 1. FIGS. 3A and 3B are sectional views taken along lines IIIA-IIIA and IIIB-IIIB in FIG. 2, respectively, of the power generator 10. The sectional view of FIG. 2 is one taken along line in FIG. 3A.

The power generator 10 includes a casing 11, a shaft 12, a pyroelectric part 13 (ferroelectric part) and a heating-side heat switch 14.

The casing 11 has the heating medium inlet 10a, cooling medium inlet 10c and cooling medium outlet 10d of the power generator 10, as illustrated in FIG. 1. Inside the casing 11, a heating medium flow path 111 for the heating medium to flow through and a cooling medium flow path 112 for the cooling medium to flow through are formed and partitioned from each other. Specifically, the casing 11 cab correspond to a flow path forming member, which defines the heating medium flow path 111 and the cooling medium flow path 112.

In FIG. 2, hatched arrows represent the flow of the heating medium along the heating medium flow path and blank arrows represent the flow of the cooling medium along the cooling medium flow path.

The heating medium flow path 111 has multiple heating-side annular portions 111a. As illustrated in FIG. 3A, in each heating-side annular portion 111a, the heating medium flows annularly. The heating-side annular portions 111a serve to cool the pyroelectric part 13.

As illustrated in FIG. 2, the multiple heating-side annular portions 111a are coaxially provided and communicate with the heating medium inlet 10a via heating medium lead-in portions 111b of the heating medium flow path 111. As illustrated in FIG. 3A, the heating medium lead-in portions 111b communicate with an outer boundary portion (outer peripheral portion) of each heating-side annular portion 111a to cause the heating medium to be tangentially introduced into each heating-side annular portion 111a.

As illustrated in FIG. 2, the casing 11 has an accommodation space 113, which is formed in an inner part of the heating-side annular portions 111a to accommodate the shaft 12. The accommodation space 113 extends in an axial direction of the heating-side annular portions 111a and communicates with the multiple heating-side annular portions 111a.

The shaft 12 is provided coaxially with the heating-side annular portions 111a and is supported by the inner wall of the accommodating space 113 via bearings 15. Because of this, the shaft 12 is rotatable inside the casing 11. In the example illustrated in FIG. 2, the rotation angle of the shaft 12 can be detected by a rotation angle sensor 16.

The shaft 12 has a hollow cylindrical shape. As illustrated in FIG. 3A, a cylindrical wall of the shaft 12 has holes 12a, through which the heating medium coming through the heating-side annular portions 111a flows in. As illustrated in FIG. 2, the heating medium outlet 10b of the power generator 10 is formed at one end of the shaft 12.

The cooling medium flow path 112 in the casing 11 has multiple cooling-side annular portions 112a communicating with the cooling medium inlet 10c and the cooling medium outlet 10d. The cooling-side annular portions 112a serve to cool the pyroelectric part 13 and are arranged opposed to the heating-side annular portions 111a. The cooling-side annular portions 112a cause the cooling fluid to flow annularly. In the present example, the multiple cooling-side annular portions 112a communicate with each other such that the cooling medium flowing in through the cooling medium inlet 10c flows through the multiple cooling-side annular portions 112a in series toward the cooling medium outlet 10d.

In the casing 11, the flat pyroelectric part 13 (ferroelectric part) is provided on a partition wall, which partitions the heating-side annular portion 111a and the cooling-side annular portion 112a. Specifically, the partition wall in the casing 11 can correspond to a base part for holding the pyroelectric part 13.

The pyroelectric part 13 is provided in the partition wall in the casing 11 such that one plate surface of the pyroelectric part 13 faces onto the heating-side annular portion 111a while the other plate surface of the pyroelectric part 13 faces onto the cooling-side annular portion 112a.

As illustrated in FIG. 3B, multiple pyroelectric parts 13 are provided on each partition wall. Each pyroelectric part 13 is approximately shaped like a flat fan and are uniformly spaced apart along the circumferential direction of the heating-side annular portions 111a (or, in other words, along the circumferential direction of the cooling-side annular portions 112a).

Each pyroelectric part 13 is subjected to the heat transfer both from the heating medium in a heating-side annular portion 111a and from the cooling medium in a cooling-side annular portion 112a. To be concrete, each pyroelectric part 13 is heated by the heating medium in the adjacent heating-side annular portion 111a and is cooled by the cooling medium in the adjacent cooling-side annular portion 112a.

As illustrated in FIG. 2, each heating-side annular portion 111a is provided with a heating-side heat switch 14. The heating-side heat switch 14 can serves as a thermal resistance changing means or a thermal resistance changer for changing the thermal resistance between the heating medium in the corresponding heating-side annular portion 111a and the pyroelectric part 13 provided in the heating-side annular portion 111a. The heating-side heat switch 14 is made of a heat insulating material such as ceramics or resin. It may be preferable that the heating-side heat switch 14 have an electrically insulating property. For higher thermal insulation, the heating-side heat switch 14 may have a hollow structure.

As illustrated in FIG. 3A, in each heating-side annular portion 111a, the shape, number and arrangement of the heating-side heat switches 14 correspond to those of the pyroelectric parts 13. To be more concrete, each heating-side heat switch 14 is shaped approximately like a fan and slightly larger than the pyroelectric part 13. In each heating-side annular portion 111 a, the heating-side heat switches 14 as many as the pyroelectric parts 13 are mutually spaced apart at regular intervals.

The heating-side heat switches 14 are connected to the shaft 12 and are rotatable integrally with the shaft 12. Hence, the heating-side heat switches 14 can rotate relative to the pyroelectric parts 13. Furthermore, the heating-side heat switches 14 can be rotated about the shaft 12 by the kinetic energy of the heating medium flowing circularly in the heating-side annular portions 111a.

Next, operation of the power generator 10 will be described. As illustrated in FIG. 2, the heating medium flowing in from the heating medium inlet 10a is led into the heating-side annular portion 111a. To be more concrete, as illustrated in FIG. 3A, the heating medium is introduced tangentially into an outer boundary portion (outer peripheral portion) of the heating-side annular portions 111a and then circularly flows in the heating-side annular portions 111a.

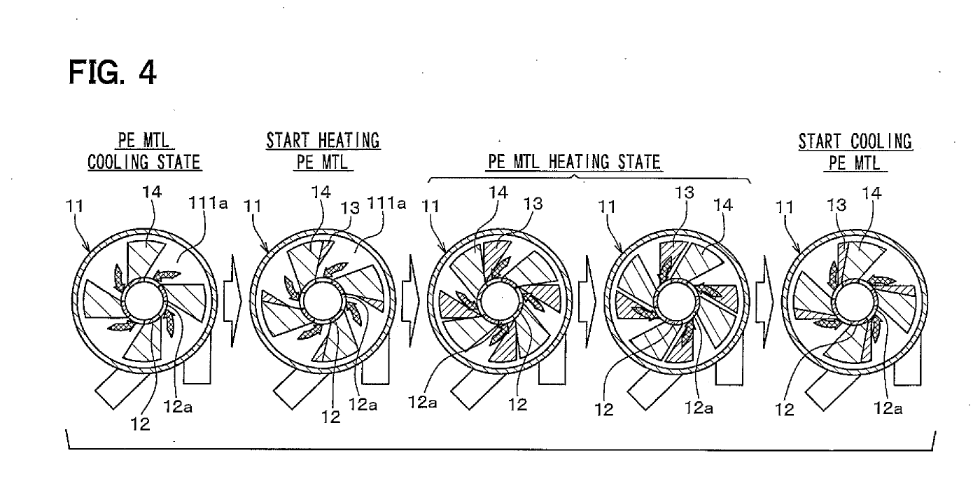

As the kinetic energy of the heating medium flowing in the heating-side annular portion 111a rotates the heating-side heat switches 14, the heating-side heat switches 14 repeat alternately overlapping with and separating from the pyroelectric parts 13 as illustrated in FIG. 4.

The heating medium introduced into the heating-side annular portion 111a enters the inside of the shaft 12 through the holes 12a formed through the cylindrical wall of the shaft 12 as illustrated in FIG. 3A, and thereafter flows out through the heating medium outlet 10b. Thus, the heating medium enters the heating-side annular portion 111a from an outer peripheral side of the heating-side annular portions 111a and exits from a central portion of the heating-side annular portion 111a.

The cooling medium flowing in from the cooling medium inlet 10c flows out from the cooling medium outlet 10d after flowing through the multiple cooling-side annular portions 112a, as illustrated in FIG. 2. Specifically, the cooling medium enters the cooling-side annular portion 112a from an outer peripheral side of the cooling-side annular portion 112a and exits from an outer peripheral side of the cooling-side annular portion 112a.

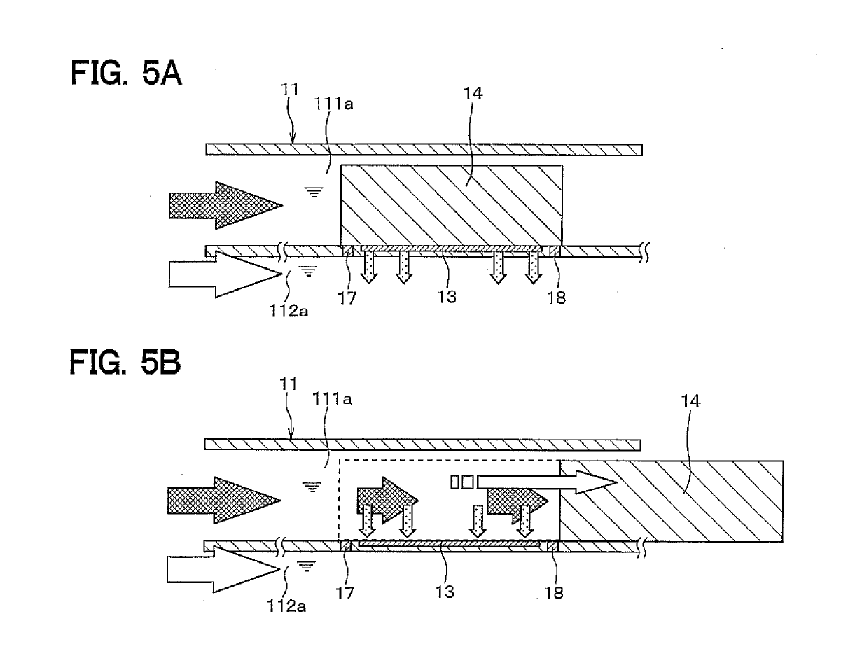

FIG. 5A is a sectional view illustrating a state where the heating-side heat switch 14 is overlapped with the pyroelectric part 13. When the heating-side heat switch 14 overlaps the pyroelectric part 13, the thermal resistance between the heating medium and the pyroelectric part 13 increases, so that the heating-side heat switch 14 serves to suppress the heat transfer from the heating medium to the pyroelectric part 13.

In the above state, therefore, the heat transfer (heat flow) from the pyroelectric part 13 to the cooling medium as indicated by dotted arrows in FIG. 5A cools the pyroelectric part 13. Specifically, the upper side of the pyroelectric part 13 is thermally insulated by the heating-side heat switch 14.

FIG. 5B is a sectional view schematically illustrating a state where the heating-side heat switch 14 is separated from the pyroelectric part 13. When the heating-side heat switch 14 is separated from the pyroelectric part 13, the thermal resistance between the heating medium and the pyroelectric part 13 decreases. In this state, heat is transferred from the heating medium to the pyroelectric part 13 as indicated by dotted arrows in FIG. 5B, thereby heating the pyroelectric part 13. Specifically, the upper side of the pyroelectric part 13 is not thermally-insulated by the heating-side heat switch 14.

As described above, as the heating-side heat switches 14 rotate, the heating-side heat switches 14 repeat alternately overlapping with and separating from the pyroelectric parts 13, so that the pyroelectric part 13 repeats being cooled and being heated alternately.

To be more concrete, when the heating-side heat switch 14 entirely overlaps ith the pyroelectric part 13 as illustrated in the leftmost of FIG. 4, the pyroelectric part 13 is in a cooled state. As the heating-side heat switch 14 rotates from the state illustrated in the leftmost of FIG. 4 and the overlapping area between the pyroelectric part 13 and the heating-side heat switch 14 starts decreasing as illustrated in the second left of FIG. 4, the pyroelectric part 13 start being heated.

As the heating-side heat switch 14 further rotates and is entirely separated from the pyroelectric part 13 as illustrated in the third and fourth [eft of FIG. 4, the pyroelectric part 13 enters the heated state.

As the heating-side heat switch 14 further rotates and starts partly overlapping with the pyroelectric part 13 as illustrated in the rightmost of FIG. 4 (with increasing overlapping area), the pyroelectric part 13 starts being cooled. As the heating-side heat switch 14 further rotates, the pyroelectric part 13 returns to the state as illustrated in the leftmost of FIG. 4.

As the drive circuit 57 (which may correspond to an electric field application means or an electric field applicator) illustrated in FIG. 1 changes the electric field applied to the pyroelectric part 13 in synchronization with timing of repeatedly heating and cooling the pyroelectric parts 13, electric power can be took out from the power generator 10. That is, pyroelectric power generation can be performed.

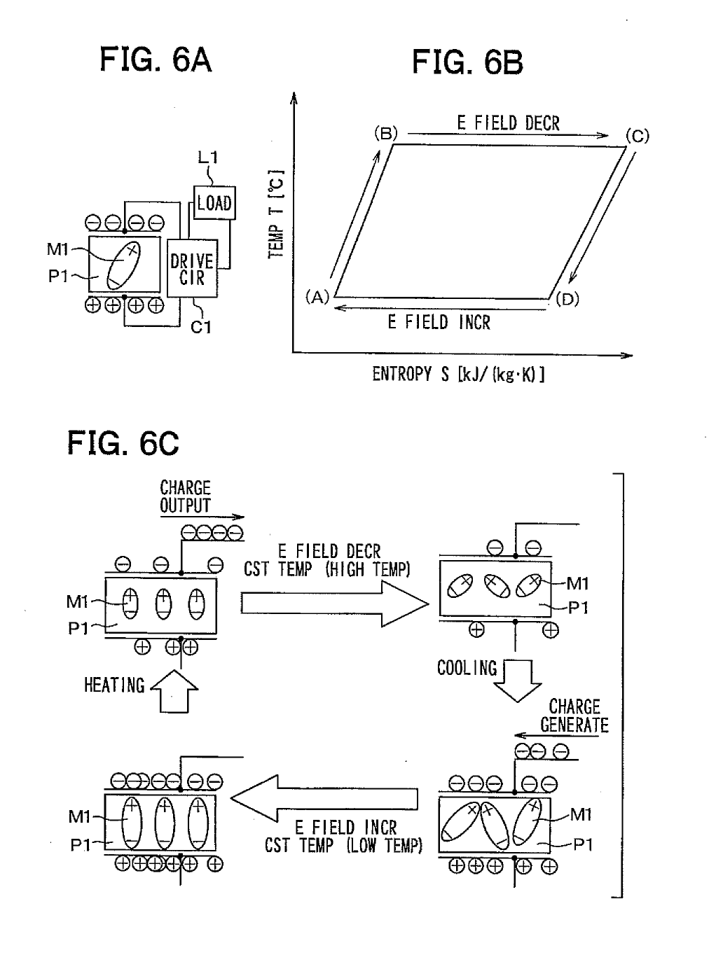

A principle of pyroelectric power generation will be outlined below with reference to FIGS. 6A to 6C. FIG. 6A shows a model describing a principle of pyroelectric power generation. FIG. 6B is a TS diagram (temperature entropy diagram) representing an operation cycle of the model illustrated in FIG. 6A. FIG. 6C illustrates behaviors of the model corresponding to the states illustrated in FIG. 6B.

In the model illustrated in FIG. 6A, a pyroelectric part P1 is electrically connected to a load LI via a drive circuit Cl.

In the TS diagram illustrated in FIG. 6B, in a state during transition from (A) to (B), the pyroelectric part P1 is heated and a constant electric field (high electric field) is applied to the pyroelectric part P1. This state will hereinafter be referred to as a state of “heating in a constant field.” When the pyroelectric part P1 is heated in a constant electric field, dipole moments M1 are uniformly oriented and the heated pyroelectric part P1 outputs electric charges.

In a state during transition from (B) to (C), the temperature of the pyroelectric part P1 is kept constant (at high temperature) and the electric field is reduced. This state will hereinafter be referred to as a state of “field reduction at a constant temperature.” When the pyroelectric part P1 is in a state of field reduction at a constant temperature where the electric field applied to the pyroelectric part P1 is reduced, the dipole moments M1 are randomly oriented.

In a state during transition from (C) to (D), the pyroelectric part P1 is cooled and the electric field applied to the pyroelectric part P1 is kept at a low level. This state will hereinafter be referred to as a state of “cooling in a constant field.” When the pyroelectric part P1 is cooled in a constant electric field, the pyroelectric part 13 being cooled generates charges.

In a state during transition from (D) to (A), the temperature of the pyroelectric part P1 is kept constant (at low temperature) and the electric field is increased. This state will hereinafter be referred to as a state of “field increase at a constant temperature.” When the pyroelectric part P1 is in a state of field increase, at a constant temperature where the electric field applied to the pyroelectric part P1 is increased, the dipole moments M1 are uniformly oriented.

By repeating the above cycle going through (A) to (D), it is possible to continuously generate the power. Specifically, in the pyroelectric power generation, the electric charges generated by the pyroelectric effect of the pyroelectric part P1 made of a ferroelectric material is taken out. Additionally, the entropy difference between multiple states caused by cyclically changing the electric field and temperature is taken out as energy.

In order to cyclically change the temperature, the present embodiment rotates, the heating-side heat switches 14 in the heating-side annular portions 111a as described above, thereby causing the heating-side heat switches 14 to repeat alternately overlapping with and separating from the pyroelectric parts 13 so as to change the thermal resistance between the heating medium and the pyroefectric part 13.

In other words, the pyroelectric part 13, which has a flat plate shape whose one surface is kept at a certain temperature, repeats contacting and non-contacting with the different temperature-range fluid, so that the input of heat to the pyroefectric parts 13 is repeatedly turned on and off and that the temperature distribution of the composite body, which includes the pyroelectric parts 13 and a base material is subjected to a heating-cooling cycle.

In the above-described way, the temperature of the pyroelectric parts 13 can be periodically changed without requiring the pyroelectric parts 13 to move back and forth between the heating medium flow path 111 and the cooling medium flow path 112. This prevents the heating medium and the cooling medium from being mixed. Therefore, the heat transfer loss caused by mixing of the heating medium and the cooling medium can be eliminated.

Moreover, in the present embodiment, since the heating-side heat switches 14 are rotated by the kinetic energy of the heating medium, a mechanism for rotating the heating-side heat switches 14 can be simplified.

Furthermore, since the heating medium is introduced into the heating-side annular portion 111a (which is the area where the heating-side heat switch 14 rotates) from an outer peripheral portion of the heating-side annular portion 111a in the circumferential rotation direction of the heating-side heat switch 14, the heating-side heat switches 14 can effectively rotate by the kinetic energy of the heating medium.

It may be preferable to set thickness of the heating-side heat switch 14, so that thermal resistance of the heating-side heat switch 14 is greater than that determined by a heat transfer coefficient of the heating medium.

In the present embodiment, both the heating medium and the cooling medium enter and exit the casing 11 in a direction parallel to the rotational axis of the heating-side heat switches 14, so that the casing 11 can be made compact.

### Second Embodiment

In a second embodiment, a concrete example of electric field application control will be described. First, a proximity sensor for detecting position of the heating-side heat switch 14 will be described. As illustrated in FIGS. 5A and 5B, the heating-side annular portion 111a is provided with a first proximity sensor 17 and a second proximity sensor 18.

The first proximity sensor 17 is positioned on a rearward side of the pyroefectric part 13 with respect to the rotational direction of the heating-side heat switch 14. In FIGS. 5A and 5B, the first proximity sensor 17 is on the left side of the in the pyroelectric part 13. The second proximity sensor 18 is positioned on a frontward of the pyroelectric part 13 with respect to the rotational direction of the heating-side heat switches 14. In FIGS. 5A and 5B, the second proximity sensor 18 is on the right side of the pyroelectric part 13.

Each of the first and second proximity sensors 17 and 18 outputs an ON signal when being close to the heating-side heat switch 14. Each of the first and second proximity sensors 17 and 18 outputs an OFF signal when being far from the heating-side heat switch 14. The first and second proximity sensors 17,18 may be, for example, hole elements.

When the heating-side heat switch 14 is entirely overlapped with the pyroelectric part 13 as illustrated in the leftmost of FIG. 4, both the first and second proximity sensors 17 and 18 are in on. When, as illustrated in the second left of FIG. 4, the overlapping area between the heating-side heat switch 14 and the pyroelectric part 13 is reduced, the first proximity sensor 17 becomes off while the second proximity sensor 18 is in on.

When the heating-side heat switch 14 is entirely separated from the pyroelectric part 13 as illustrated in the third left and the fourth left of FIG. 4, the first and second proximity sensors 17 and 18 both turn off. When the heating-side heat switch 14 and the pyroelectric part 13 start partly overlapping as illustrated in the rightmost of FIG. 4 (the overlapping area increases), the first proximity sensor 17 turns on while the second proximity sensor 18 remains off.

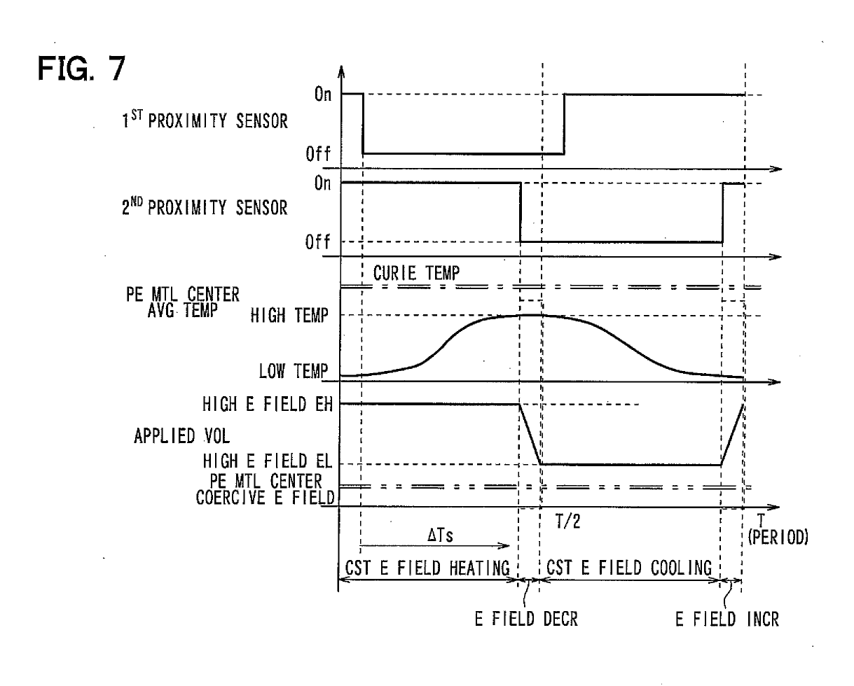

FIG. 7 is a time chart illustrating an exemplary operation. A temperature change at the center of the pyroelectric part 13 is also illustrated in FIG. 7 on assumption that the pyroelectric part 13 is adequately thin.

When the first proximity sensor 17 and the second proximity sensor 18 for the pyroelectric part 13 are in off and on, respectively, i.e. when the overlapping area between the heating-side heat switch 14 and the pyroelectric part 13 is in decrease, it can be determined that the temperature of the pyroelectric part 13 is in increase. Thus, the electric field being applied is kept high (EH) (heating in a constant field).

When both the first and second proximity sensors 17 and 18 are in off, i.e. when the heating-side heat switch 14 is entirely separated from the pyroelectric part 13, it can be determined that the temperature of the pyroelectric part 13 reaches a highest temperature. Thus, the applied electric field is reduced (field reduction at a constant temperature).

When the first proximity sensor 17 is on and the second proximity sensor 18 is off, i.e. when the heating-side heat switch 14 starts partly overlapping with the pyroelectric part 13 (when the overlapping area is in increase), it can be determined that the temperature of the pyroelectric part 13 is in decrease. Thus, the applied electric field is kept low (EL) (cooling in a constant field).

When both the first and second proximity sensors 17 and 18 are in on, i.e. when the heating-side heat switch 14 entirely overlaps with the pyroelectric part 13, it can be determined that the temperature of the pyroelectric part 13 reaches a lowest temperature. Thus, the applied electric field is increased (field increase at a constant temperature).

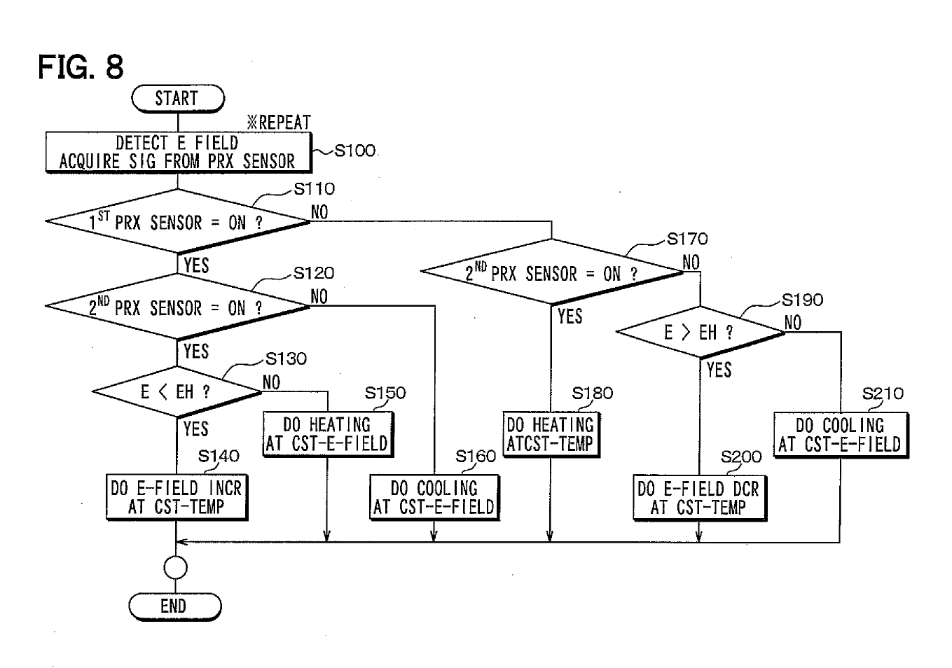

FIG. 8 is a flowchart illustrating the above electric field control. The flowchart is executed from a control device (not shown).

First, in S100, the strength of the electric field is measured and detection signals from the first and second proximity sensors 17 and 18 are acquired. To measure the strength of the electric field, an appropriate type of electric field sensor may be used.

In S110, it is determined whether the first proximity sensor 17 is on. When it is determined the first proximity sensor 17 is on (YES at S110), processing advances to S120. In S120, it is determined whether the second proximity sensor 18 is on. When it is determined that the second proximity sensor 18 is on (YES at 5120), processing advances to S130. In S130, it is determined whether the measured electric field strength E is smaller than the high electric field value EH.

When it is determined that the measured electric field strength E is smaller than the high electric field value EH (YES at 8130), processing advances to S140. In 5140, a constant temperature field increase is performed. Specifically, in concrete terms, the electric field is increased.

When it is determined in S130 that the measured electric field strength E is not smaller than the high electric field value EH (NO at S130), processing advances to S150. In S150, a constant field heating is performed. Specifically, in concrete terms, the electric field is maintained.

When it is determined in 5120 that the second proximity sensor 18 is off (NO at s120), processing advances to S160. In S160, a constant field cooling is performed. Specifically, in concrete terms, the electric field is maintained.

When it is determined in S110 that the first proximity sensor 17 is off (NO at 8110), processing advances to S170. In S170, it is determined whether the second proximity sensor 18 is in on. When it is determined that the second proximity sensor 18 is in on (YES at S170), processing advances to S180. In 5180, a constant field heating is performed. Specifically, in concrete terms, the electric field is maintained.

When it is determined in S170 that the second proximity sensor 18 is off (NO at S170), processing advances to S190. In 8190, it is determined whether the measured electric field strength E is larger than the low electric field value EL.

When it is determined that the measured electric field strength E is larger than the low electric field value EL (YES at S190), processing advances to S200. In S200, a constant temperature field reduction is performed. Specifically, in concrete terms, the electric field is reduced.

When it is determined in 5190 that the measured electric field strength E is not larger than the low electric field value EL (NO at S190), processing advances to S210. In S210, a constant field cooling is performed. Specifically, in concrete terms, the electric field is maintained.

It should be noted that the power generator 10 may not include both of the first and second proximity sensors 17 and 18. For example, the second proximity sensor 18 may be omitted. In that case, a prescribed time ΔTs indicated in FIG. 7 may be arbitrarily set, where the prescribed time ΔTs represents a time from a time when the first proximity sensor 17 turns from on to off to a time when the state is switched to the constant temperature field reduction. When a cycle time is denoted by T, a relationship ΔTs <T/2 is satisfied.

Also, the position of the heating-side heat switch 14 may be detected with an angle sensor instead of the first and second proximity sensors 17 and 18.

### Third Embodiment

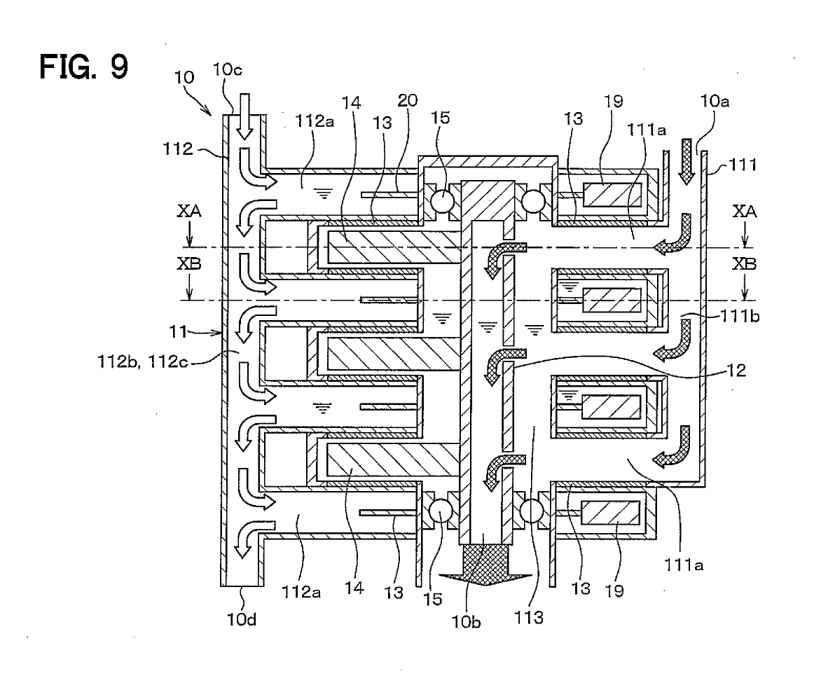

In a third embodiment, in addition to the heating-side heat switches 14 provided in the heating-side annular portion 111a as in the first and second embodiments, a cooling-side heat switch 19 is provided in the cooling-side annular portion 112a, as illustrated in FIG. 9.

The cooling-side heat switch 19 provided in a cooling-side annular portion 112a serves as a thermal resistance changing means or a thermal resistance changer for changing the thermal resistance between the cooling medium in the cooling-side annular portion 112a and the adjacent pyroelectric part 13. The cooling-side heat switch 19 is made of a heat insulating material such as ceramics or resin. It may be preferable that the cooling-side heat switch 19 have electrically insulating property. For higher thermal insulation, the cooling-side heat switch 19 may have a hollow structure.

In the present example, the cooling-side annular portion 112a communicates with the cooling medium inlet 10c via the cooling medium lead-in portion 112b of the cooling medium flow path 112 and communicates with the cooling medium outlet 10d via the cooling medium lead-out portion 112c of the cooling medium flow path 112.

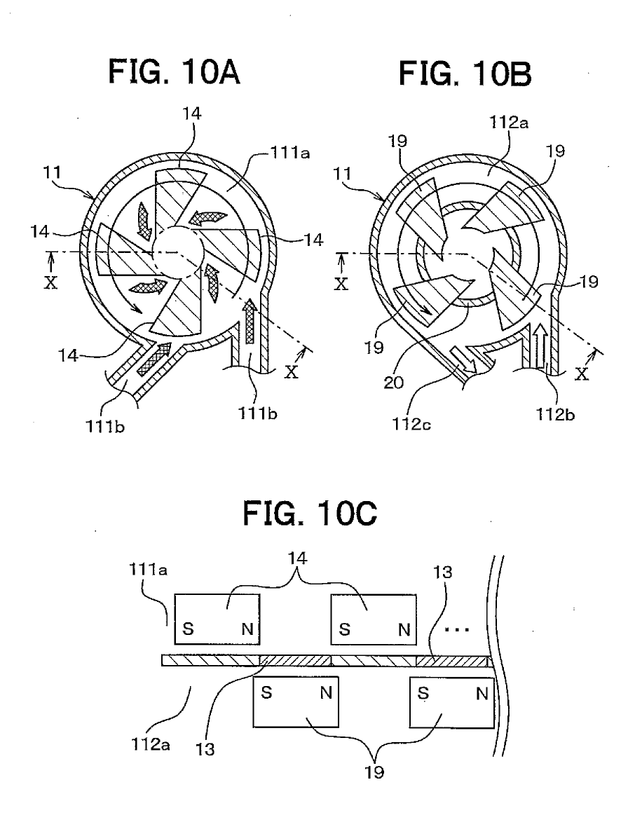

As illustrated in FIG. 10B, the cooling medium lead-in portion 112b and the cooling medium lead-out portion 112c communicate with an outer boundary portion (outer peripheral portion) of the cooling-side annular portion 112a, and the cooling medium is led into and led out from the cooling-side annular portion 112a in a tangential direction.

The heating medium flow path 111 can have substantially the same configuration as in the first and second embodiments. Hence, in the present embodiment, the heating medium flows into the heating-side annular portion 111a from an outer peripheral side and flows out from a central portion whereas the cooling medium flows into the cooling-side annular portion 112a from an outer peripheral side and flows out also from an outer peripheral side.

As illustrated in FIG. 10A, the heating-side heat switch 14 can have substantially the same configuration as in the first and second embodiments. As illustrated in FIG. 10B, the cooling-side heat switch 19 is, like the heating-side heat switches 14, approximately fan-shaped corresponding to the shape of the pyroelectric part 13. The cooling-side heat switch 19 is arranged in the circumferential direction of the cooling-side annular portion 112a and, like the pyroelectric part 13, they are total four in each cooling-side annular portion 112a.

The cooling-side heat switches 19 are displaced from the heating-side heat switches 14. To be more concrete, each cooling-side heat switch 19 is positioned between heating-side heat switches 14 as seen in the axial direction of the heating-side annular portions 111a and cooling-side annular portions 112a.

The cooling-side heat switches 19 are mutually coupled via a rib 20 and are rotated in synchronization with the heating-side heat switches 14 using magnetic coupling. FIG. 10C shows an example of magnetic coupling configuration (an example arrangement of N/S magnet poles).

In the present embodiment, the heating-side heat switches 14 and the cooling-side heat switches 19 are synchronized with a certain phase difference (0 to π).

To be more concrete, when the heating-side heat switches 14 are overlapped with the pyroelectric parts 13, the cooling-side heat switches 19 are separated from the pyroelectric parts 13; and, when the cooling-side heat switches 19 are overlapped with the pyroelectric parts 13, the heating-side heat switches 14 are separated from the pyroelectric parts 13.

When, as described above, the heating-side heat switches 14 are separated from the pyroelectric parts 13, the cooling-side heat switches 19 are overlapped with the pyroelectric parts 13. In this state, the pyroelectric parts 13 are heated by the heating medium in the heating-side annular portions 111a, whereas cooling of the pyroelectric parts 13 by the cooling medium in the cooling-side annular portions 112a is suppressed by the heat insulation effect of the cooling-side heat switches 19. Therefore, compared with the first embodiment, the pyroelectric parts 13 can be heated efficiently in the present embodiment.

Also, since the heating-side heat switches 14 and the cooling-side heat switches 19 are rotated in synchronization by magnetic coupling, the heating medium and the cooling medium can be securely prevented from mixing.

### Fourth Embodiment

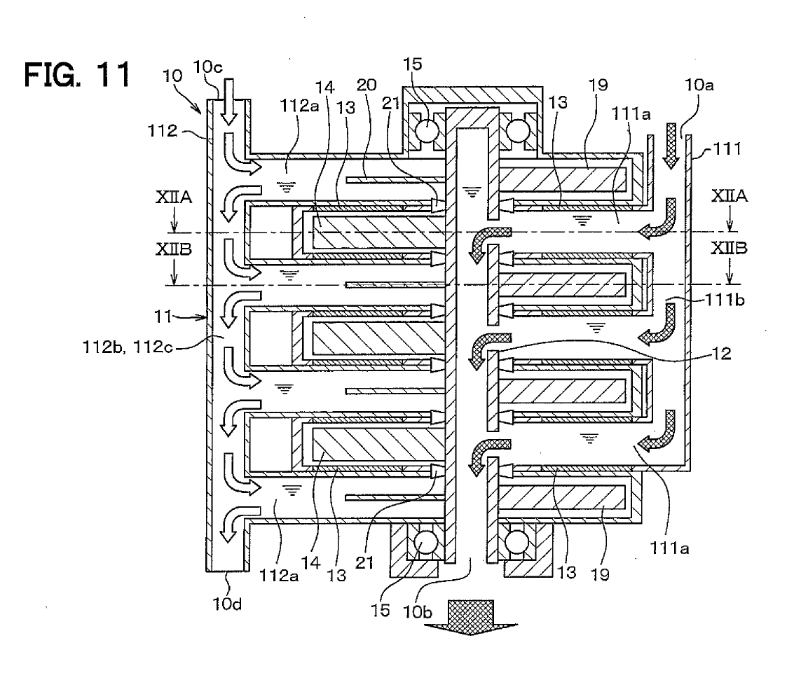

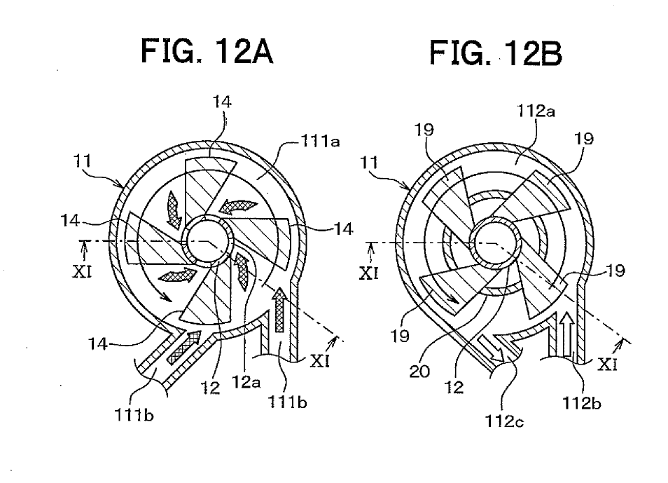

In a fourth embodiment, the cooling-side heat switches 19 are mechanically coupled with the heating-side heat switches 14 as illustrated in FIG. 11 and FIGS. 12A and 12B, thereby allowing the heating-side heat switches 14 and the cooling-side heat switches 19 to be rotated in synchronization without use of the magnetic coupling, unlike in the third embodiment where the heating-side heat switches 14 and the cooling-side heat switches 19 are rotated in synchronization by the magnetic coupling.

To be more concrete, the accommodation space 113 provided in the third embodiment is not provided in the fourth embodiment. In the fourth embodiment, the shaft 12 is provided to extend through a center of the heating-side annular portion 111a and the cooling-side annular portion 112a while the cooling-side heat switch 19 is coupled to the shaft 12.

In this configuration, the outer peripheral surface of the shaft 12 is exposed to the cooling-side annular portion 112a, so that a lip seal 21 is provided between the outer peripheral surface of the shaft 12 and a wall portion of the casing 11. This securely prevents the mixing of the heating medium and the cooling medium.

### Fifth Embodiment

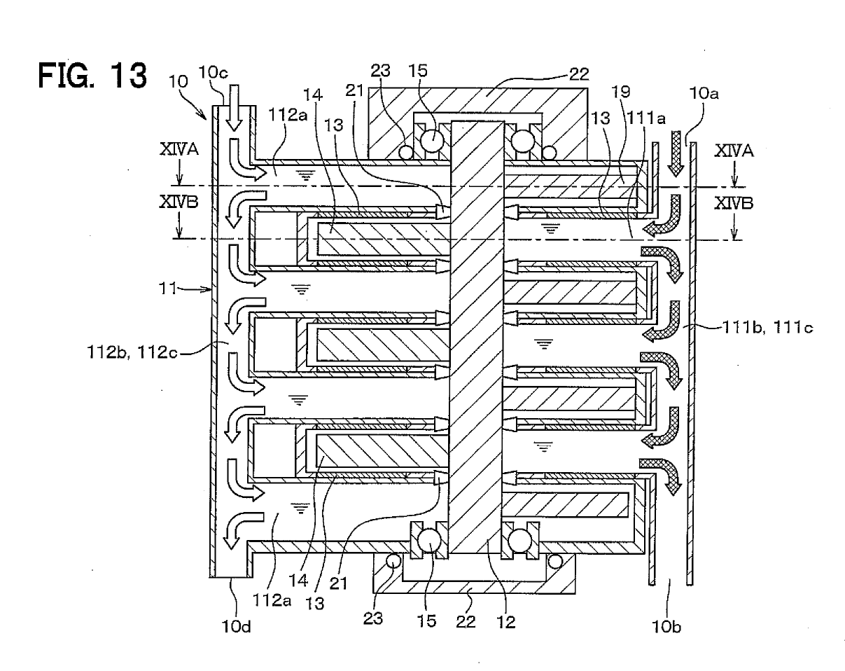

In a fifth embodiment, the heating medium outlet 10b is formed in the casing 11 as illustrated in FIG. 13, unlike in the fourth embodiment where the heating medium outlet 10b of the power generator 10 is formed in an end portion of the shaft 12 as illustrated in FIG. 1.

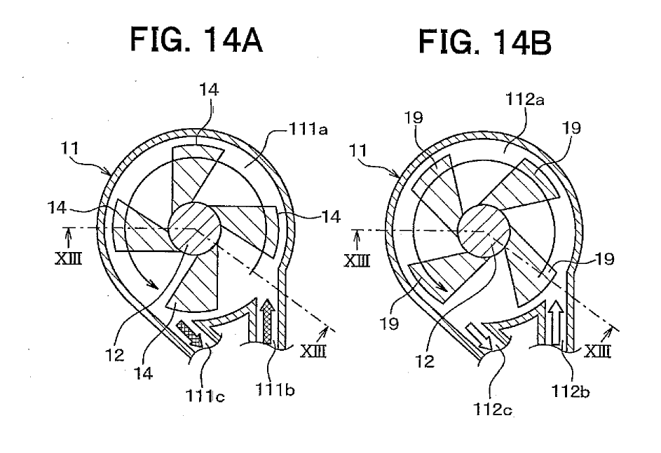

Also, the heating-side annular portion 111a communicates with the heating medium outlet 10b via the heating medium lead-out portion 111c of the heating medium flow path 111. To be more concrete, as illustrated in FIG. 14A, the heating medium lead-out portion 111c communicates with an outer boundary portion (outer peripheral portion) of the heating-side annular portion 111a, thereby allowing the heating medium in the heating-side annular portion 111a to be led out in a tangential direction of the heating-side annular portion 111a without passing through the inside of the shaft 12.

Therefore, in the present embodiment, the heating medium flows into the heating-side annular portion 111a from an outer peripheral side of the heating-side annular portion 111a and flows out to an outer peripheral side of the heating-side annular portion 111a, whereas the cooling medium flows into the cooling-side annular portion 112a from an outer peripheral side of the cooling-side annular portion 112a and flows out to an outer peripheral side of the cooling-side annular portion 112a.

In the example illustrated in FIG. 13, the casing 11 is provided with a cover 22 that covers each of opposite ends of the shaft 12 via an O-ring 23. The O-rings 23 is provided to prevent the cooling medium in the cooling-side annular portion 112a from leaking out.

### Sixth Embodiment

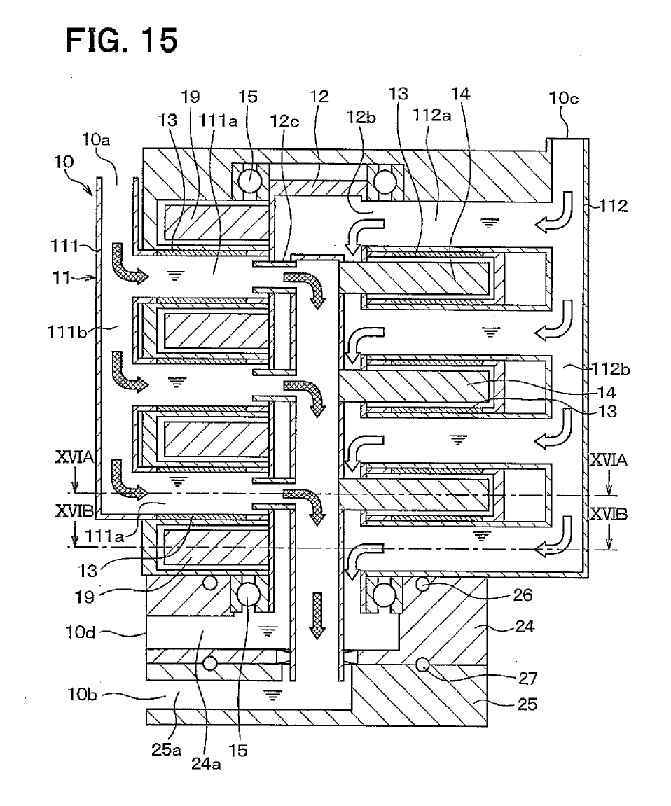

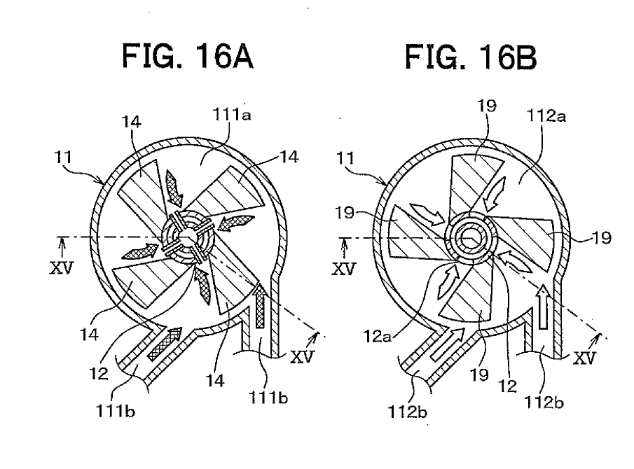

In a sixth embodiment, the cooling medium circularly flowing through the cooling-side annular portion 112a is led out through a central portion of the cooling-side annular portion 112a as illustrated in FIGS. 15 and 16B, unlike in the fourth embodiment where the cooling medium circularly flowing through the cooling-side annular portion 112a is led out via an outer boundary portion (outer peripheral portion) of the cooling-side annular portion 112a.

To be more concrete, the shaft 12 has a double-layered cylindrical structure (multiple-layered cylindrical structure) which includes an inner cylindrical portion through which the heating medium flows and an outer cylindrical portion through which the cooling medium flows.

The shaft 12 has holes 12b formed through the outer peripheral wall thereof to allow the cooling medium in the cooling-side annular portions 112a to flow into the outer cylindrical portion thereof. The shaft 12 also has communication tubes 12c provided to allow the heating medium in the heating-side annular portions 111a to flow into the inner cylindrical portion of the shaft 12. The communication tubes 12c extend through the outer cylindrical portion of the shaft 12 along the radial direction of the shaft 12.

In the example illustrated in FIG. 15, covers 24 and 25 covering one end of the shaft 12 have the heating medium outlet 10b and cooling medium outlet 10d of the power generator 10 illustrated in FIG. 1 formed in them respectively.

To be more concrete, the cover 24 covering one end of the inner cylindrical portion of the shaft 12 has the cooling medium outlet 10d formed therein and the cover 25 covering one end of the outer cylindrical portion of the shaft 12 has the heating medium outlet 10b formed therein. The cover 24 is attached to the casing 11 via an O-ring 26. The cover 25 is attached to the cover 24 via an O-ring 27.

The cover 24 includes a flow path 24a formed for communication between the outer cylindrical portion of the shaft 12 and the cooling medium outlet 10d. The cover 25 has a flow path 25a formed for communication between the inner cylindrical portion of the shaft 12 and the heating medium outlet 10b.

According to the present embodiment, the heating medium can be led into the heating-side annular portions 111a from an outer peripheral side of the heating-side annular portions 111a and led out through a central portion of the heating-side annular portions 111a, whereas the cooling medium can be led into the cooling-side annular portions 112a from an outer peripheral side of the cooling-side annular portions 112a and led out through a central portion of the cooling-side annular portions 112a.

### Seventh Embodiment

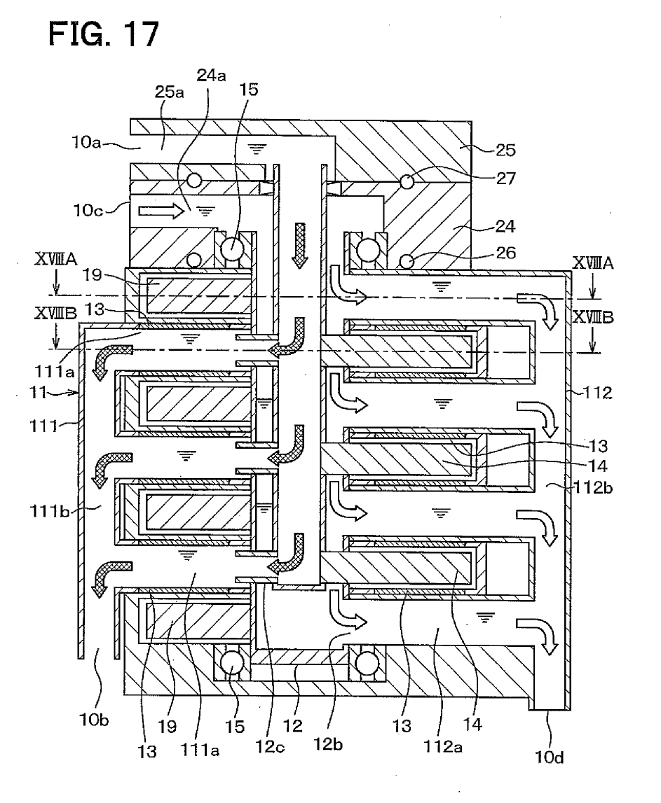

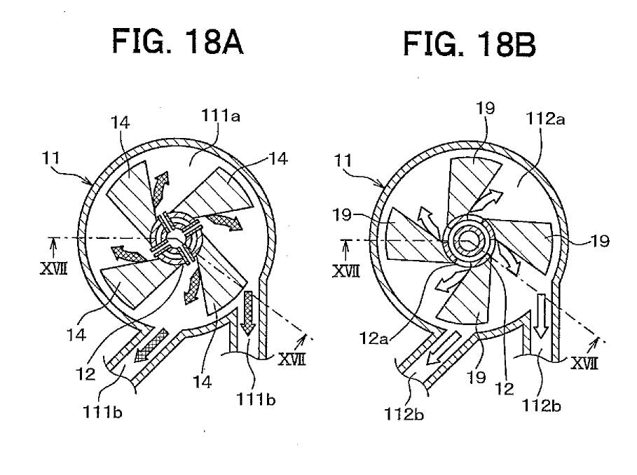

In a seventh embodiment, as illustrated in FIG. 17 and FIGS. 18A and 18B, the flowing directions of the heating medium and the cooling medium are reversed with respect to the sixth embodiment. Specifically, in the seventh embodimen, the positions of the heating medium inlet 10a and heating medium outlet 10b are reversed and the positions of the cooling medium inlet 10c and cooling medium outlet 10b are reversed with respect to the sixth embodiment.

According to the present embodiment, the heating medium enters the heating-side annular portion 111a through a central portion of the heating-side annular portion 111a and exits through an outer peripheral portion of the heating-side annular portion 111a, whereas the cooling medium enters the cooling-side annular portion 112a also through a central portion of the cooling-side annular portion 112a and exits through an outer peripheral portion of the cooling-side annular portion 112a.

### Eighth Embodiment

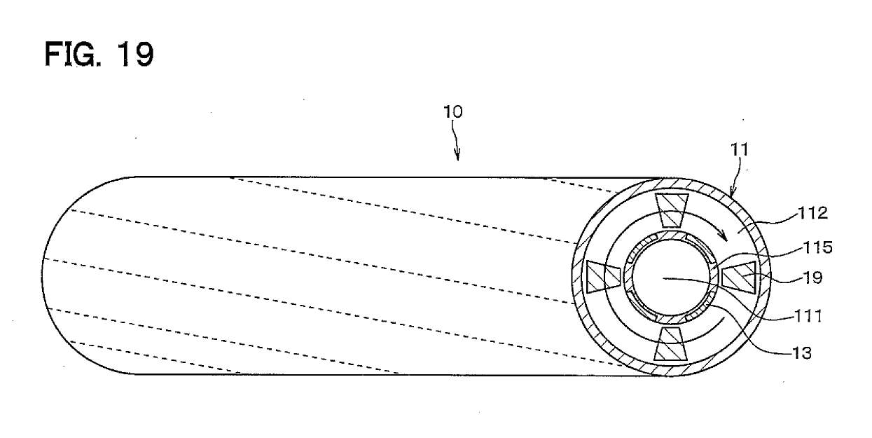

FIG. 19 is a schematic diagram of the power generator 10 according to an eighth embodiment. The casing 11 has a double-layered cylindrical structure which includes an inner cylindrical portion defining the heating medium flow path 111 and an outer cylindrical portion defining the cooling medium flow path 112. The heating is medium flows through the heating medium flow path 111 and the cooling medium flows through the cooling medium flow path 112 both along the axial direction of the casing 11.

The pyroelectric parts 13 are provided on a cylindrical wall 115 which partitions the heating medium flow path 111 (outer cylindrical portion) and the cooling medium flow path 112 (inner cylindrical portion). The multiple cooling-side heat switches 19 are provided in the cooling medium flow path 112.

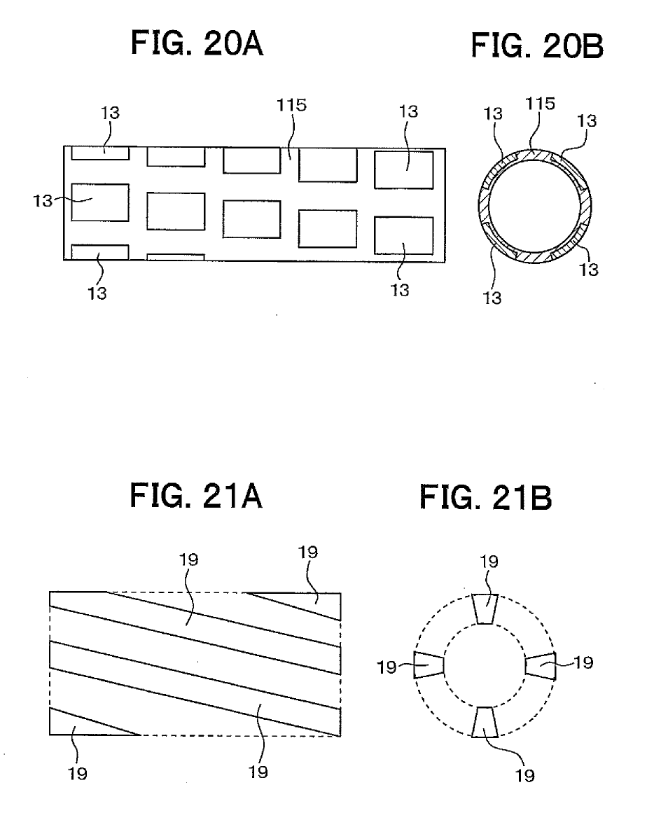

As illustrated in FIG. 20B, the pyroelectric part 13 is curved to fit the cylindrical wall 115. Four (multiple) pyroelectric parts 13 are arranged at regular intervals in the circumferential direction of the casing 11. Multiple pyroelectric parts 13 are also arranged at regular intervals in the axial direction of the casing 11. As illustrated in FIG. 20A, the pyroelectric parts 13 are arranged to be gradually displaced in the circumferential direction when seen from one axial end toward the other axial end of the casing 11, so that they as a whole appear being spirally arranged.

As illustrated in FIGS. 21A and 21B, the number of cooling-side heat switches 19 is four and equal to the number of pyroelectric parts 13 arranged in the circumferential direction of the casing 11.

The multiple cooling-side heat switches 19 spirally extend in the axial direction of the casing 11 and are mutually linked in a manner to be arranged at regular intervals in the circumferential direction. In FIG. 19 and FIGS. 21A and 21B, the members linking the multiple cooling-side heat switches 19 are omitted.

The multiple mutually linked cooling-side heat switches 19 are not fixed to the casing 11. They are floating or suspended in the cooling medium in the cooling medium flow path 112.

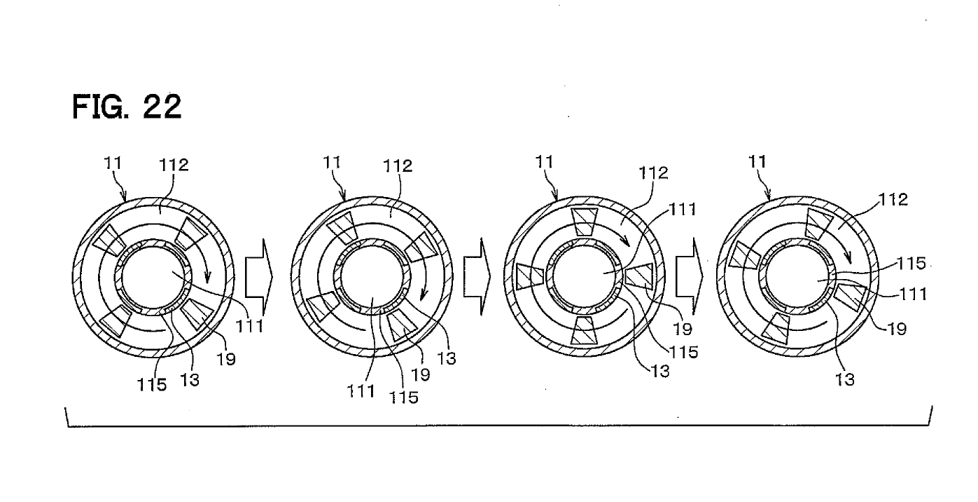

In the above configuration, the power generator can operate in the following way. When the cooling medium flows through the cooling medium flow path 112 in the axial direction of the casing 11, the spirally extending cooling-side heat switches 19 are rotated by the kinetic energy of the cooling medium. This causes, as illustrated in FIG. 22, the cooling-side heat switches 19 to repeat alternately overlapping with and separating from the pyroelectric parts 13, thereby enabling pyroelectric power generation as in the foregoing embodiments.

According to the present embodiment, the casing 11 has a simple double-layered cylindrical structure. Therefore, the structure of the power generator 10 as a whole can be simplified.

### Ninth Embodiment

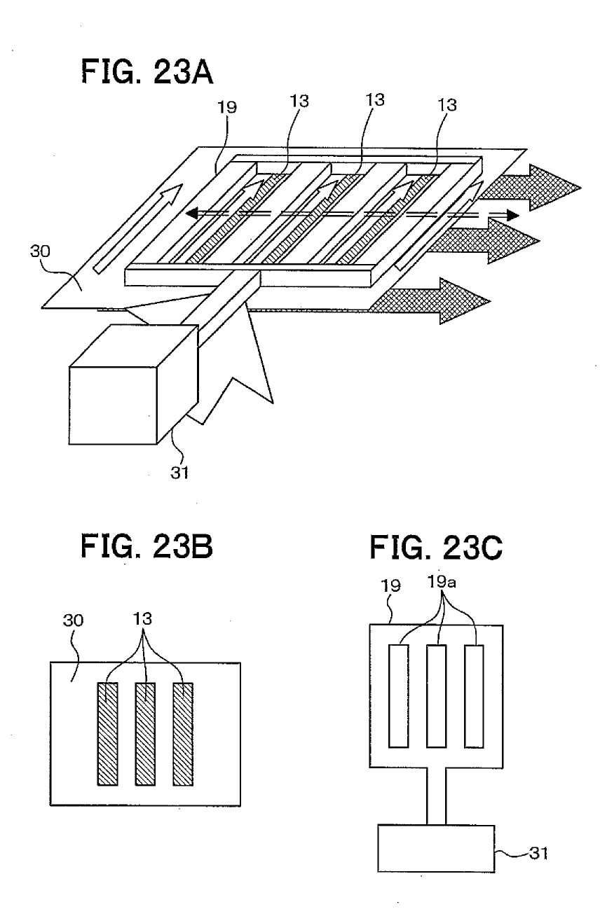

In a ninth embodiment illustrated in FIGS. 23A to 23C, the heat switches 19 are designed to move back and forth unlike in the foregoing embodiments where the heat switches 14 and 19 are designed to rotate.

FIG. 23A is a perspective view schematically illustrating a main part of the power generator according to the ninth embodiment. The pyroelectric parts 13 are formed flatly and are provided on a substrate 30 separating the heating medium flow path and the cooling medium flow path. Specifically, the substrate 30 serves as a base material to hold the pyroelectric parts 30.

In FIG. 23A, blank arrows indicate the flow of the cooling medium in the cooling medium flow path and shaded arrows indicate the flow of the heating medium in the heating medium flow path. In the example illustrated in FIG. 23A, the heating medium and the cooling medium flow in mutually perpendicular directions and in parallel with the plane of the substrate 30. Also in FIG. 23A, broken-line arrows indicate directions in which the heat switch 19 moves back and forth.

FIG. 23B is a plan view of the pyroelectric parts 13 and the substrate 30 illustrated in FIG. 23A. In the present example, the pyroelectric parts 13 are arranged to extend on the substrate 13 with uniform spacing in a direction (the left-to-right direction as seen in FIG. 23A) perpendicular to the direction of the cooling medium flow.

The cooling-side heat switch 19 provided in the cooling medium flow path is driven by a drive mechanism 31. The drive mechanism 31 moves the cooling-side heat switch 19 back and forth in a direction along the substrate 30. In other words, the cooling-side heat switch 19 moves back and forth along a virtual plane extending in parallel with the flow direction of the cooling medium.

In the present example, the drive mechanism 31 includes a water wheel and a direct action mechanism (for example, a scotch yoke mechanism or a piston crank mechanism). The water wheel included in the drive mechanism 31 is rotated by the kinetic energy of the cooling medium. The direct action mechanism included in the drive mechanism 31 converts the rotational movement of the water wheel into reciprocating movement.

Thus, the cooling-side heat switch 19 can be linearly moved back and forth by the kinetic energy of the cooling medium. Specifically, the drive mechanism 31 serves as a conversion mechanism for converting the kinetic energy of the cooling medium into reciprocating movement of the cooling-side heat switch 19.

FIG. 23C is a plan view of the cooling-side heat switch 19 and the drive mechanism 31. The cooling-side heat switch 19 has holes 19a formed to be mutually spaced apart by the distance by which the pyroelectric parts 13 are also mutually spaced apart.

In the present embodiment, the holes 19a in the cooling-side heat switch 19 are formed to extend in a direction (the left-to-right direction as seen in FIG. 23A) perpendicular to the direction of the cooling medium flow with uniform spacing. In this setup, the drive mechanism 31 moves the cooling-side heat switch 19 back and forth (in the left-to-right direction as seen in FIG. 23A) perpendicularly to the direction of the cooling medium flow.

The cooling-side heat switch 19 is set such that the pyroelectric pars 13 provided on the substrate 30 can be seen through the holes 19a formed through the cooling-side heat switch 19. This enables the drive mechanism 31 to move the cooling-side heat switch 19 back and forth such that the pyroelectric parts 13 can be repeatedly seen through the holes 19a formed through the, cooling-side heat switch 19.

According to the present embodiment, as in the foregoing embodiments, the cooling-side heat switch 19 repeats alternately overlapping with and separating from the pyroelectric parts 13, thereby causing the temperature of the pyroelectric parts 13 to change and enabling pyroelectric power generation.

### Tenth Embodiment

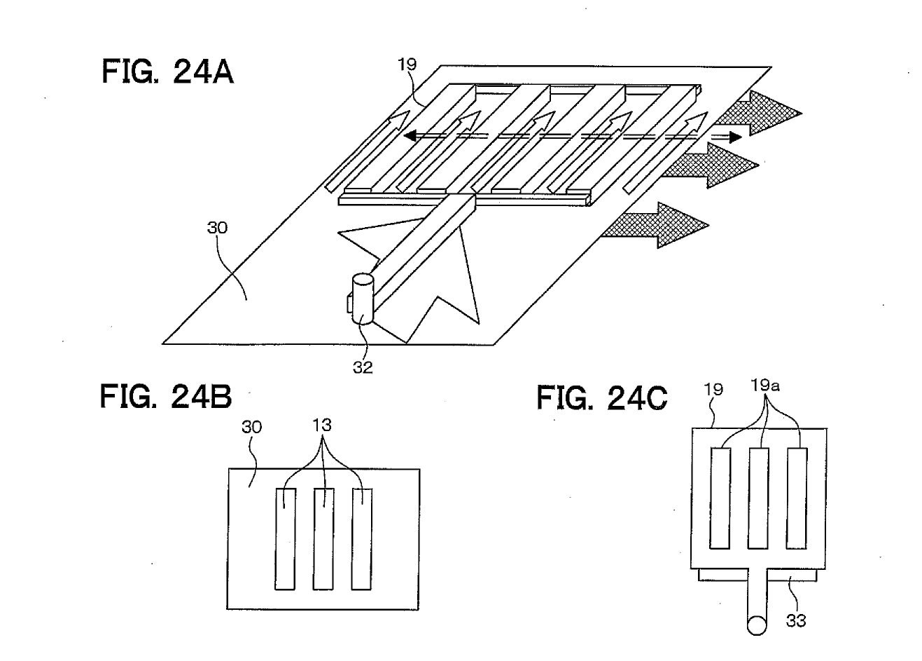

In a tenth embodiment illustrated in FIGS. 24A to 24C, the cooling-side heat switch 19 engages in self-excited oscillation based on a supporting point unlike in the ninth embodiment where the cooling-side heat switch 19 is linearly moved back and forth.

FIG. 24A is a perspective view schematically illustrating a main part of the power generator according to the tenth embodiment. FIG. 24B is a plan view illustrating the pyroelectric parts 13 and the substrate 30 illustrated in FIG. 24A. In FIG. 24A, broken-line arrows indicate directions in which the heat switch 19 moves.

In the present example, the pyroelectric parts 13 are arranged with uniform spacing on the substrate 30 to extend in a direction perpendicular to the direction of the cooling medium flow.

The substrate 30 is provided with a pin 32 to serve as a supporting point for self-excited oscillation of the cooling-side heat switch 19 linked to the pin 32.

FIG. 24C is a plan view of the cooling-side heat switch 19 and the pin 32. In the present example, the holes 19a formed through the cooling-side heat switch 19 extend in a direction perpendicular to the direction of the cooling medium flow with uniform spacing.

The cooling-side heat switch 19 includes a resistor plate 33 used to generate self-oscillation. The cooling-side heat switch 19 is set such that the pyroelectric parts 13 on the substrate 30 can be seen through the holes 19a formed through the cooling-side heat switch 19.

According to the present embodiment, by being subjected to the flow of the cooling medium, the cooling-side heat switch 19 oscillates self-excitedly while being supported by the pin 32 (supporting point). This causes the cooling-side heat switch 19 to repeat alternately overlapping with and separating from the pyroelectric parts 13, thereby changing the temperature of the pyroelectric parts 13 and enabling pyroelectric power generation.

### Eleventh Embodiment

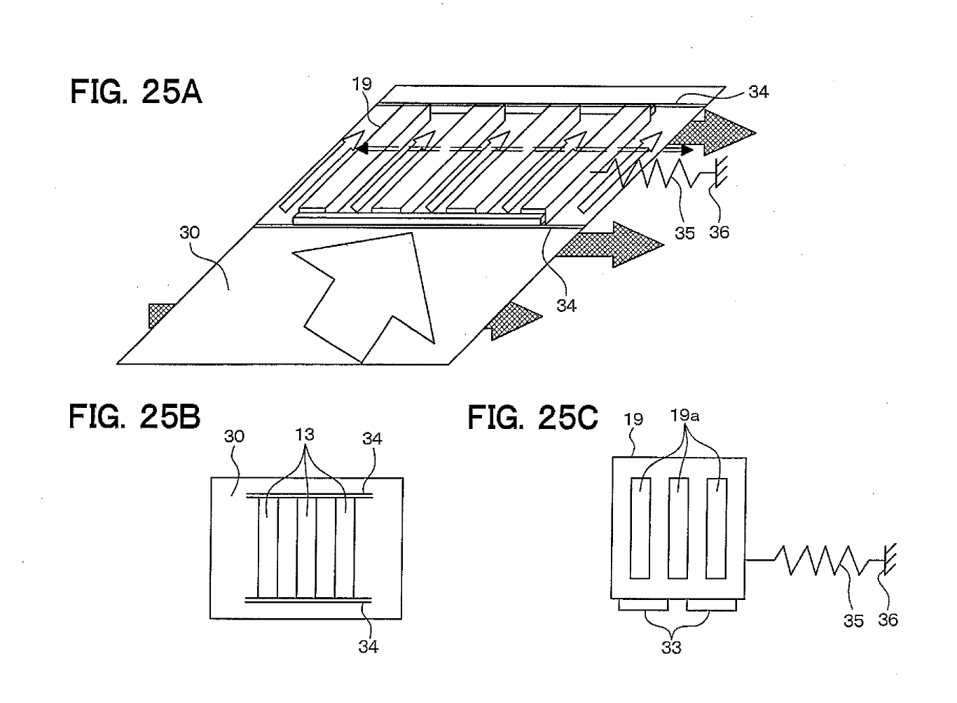

In an eleventh embodiment illustrated in FIGS. 25A to 25C, the cooling-side heat switch 19 self-excitedly oscillates linearly unlike in the tenth embodiment where the cooling-side heat switch 19 self-excitedly oscillates based on a supporting point.

FIG. 25A is a perspective view schematically illustrating a main part of the power generator according to the eleventh embodiment. In FIG. 25A, broken-line arrows indicate the directions in which the heat switch 19 moves.

The substrate 30 is provided with guides 34 which support the cooling-side heat switch 19 to be linearly movable. The cooling-side heat switch 19 is connected to a flow path wall 36 (for example, a casing wall) via a spring 35.

FIG. 25B is a plan view illustrating the pyroelectric parts 13, the substrate 30 and the guides 34 illustrated in FIG. 25A. In the present example, the pyroelectric parts 13 are arranged with uniform spacing in a direction perpendicular to the direction of the cooling medium flow and the guides 34 linearly extend perpendicularly to the direction of the cooling medium flow direction.

FIG. 25C is a plan view illustrating the cooling-side heat switch 19 and the spring 35. In the present example, the holes 19a are formed through the cooling-side heat switch 19 with uniform spacing in a direction perpendicular to the direction of the cooling medium flow.

The spring 35 serves to keep constant the frequency of driving the cooling-side heat switch 19. Specifically, the cooling-side heat switch 19 oscillates, by being subjected to the flowing cooling medium, at a natural oscillation frequency determined by the mass of itself and the spring constant of the spring 35. The direction of self-excited oscillation of the cooling-side heat switch 19 is one-dimensionally controlled by the guides 34.

Thus, the cooling-side heat switch 19 linearly oscillates perpendicularly to the direction of the cooling medium flow and repeats alternately overlapping with and separating from the pyroelectric parts 13. This causes the temperature of the pyroelectric parts 13 to change and thereby enables pyroelectric power generation.

### Twelfth Embodiment

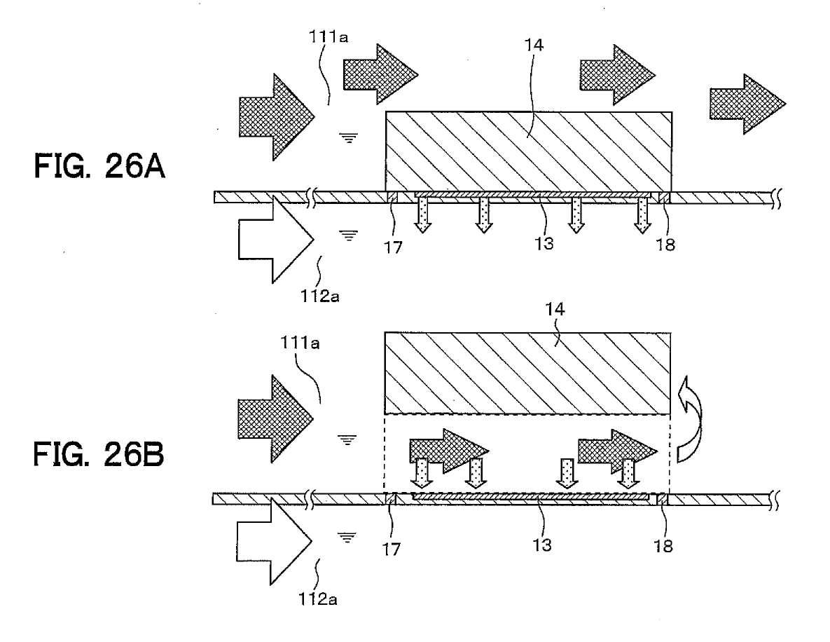

Even though, in the foregoing embodiments, the heat switches move in a direction in parallel with the faces of the pyroelectric parts, the heat switches may be moved perpendicularly to the faces of the pyroelectric parts as in a twelfth embodiment illustrated in FIGS. 26A and 26B.

FIGS. 26A and 26B are sectional views corresponding to those illustrated in FIGS. 5A and 5B. Unlike FIGS. 5A and 5B, FIGS. 26A and 26B show an example configuration in which each heating-side heat switch 14 moves perpendicularly to the face of each pyroelectric part 13 (in the vertical direction as seen in FIGS. 26A and 26B). In FIGS. 26A and 26B, dotted arrows indicate the flow of heat.

An alternative configuration in which each cooling-side heat switch 19 moves perpendicularly to the face of each pyroelectric part 13 may also be used.

### Other Embodiments

The heating medium flow path 111 and the cooling medium flow path 112 in the above embodiments may be reversed. Specifically, the cooling medium may flow through the heating medium flow path 111 and the heating medium may flow through the cooling medium flow path 112.

The operations of the heat switches 14 and 19 may include contacting the pyroelectric pars 13.

The heat switch 14 and 19 may have a vacuum interior for higher thermal insulation.

In the foregoing embodiments, the heat switches 14 and 19 are directly moved relative to the pyroelectric parts 13. However, this does not limit the arrangement. Any arrangement can be employed as long as the heat switch 14 and 19 is moved relative to the pyroelectric parts 13.

The multiple heating-side annular portions 111a in the foregoing embodiments may be made different in temperature from each other. For example, temperatures of heating units for heating the pyroelectric parts 13 may be set in a stepwise manner. In this case, the heating-side heat switches 14 may have a phase difference between the heating-side annular portions 111a.

Similarly, the multiple cooling-side annular portions 112a may be made different in temperature from each other. For example, temperatures of cooling units for cooling the pyroelectric parts 13 may be set in a stepwise manner. In this case, the cooling-side heat switches 19 may have a phase difference between the cooling-side annular portions 112a.

In the above embodiments, at least one of the thermal resistance between the heating medium and the pyroelectric parts 13 and the thermal resistance between the cooling medium and the pyroelectric parts 13 is periodically changed by the heat switches 14 and 19 (heat insulators). Alternatively, air bubbles may be generated at least either in the heating medium flow path 111 or in the cooling medium flow path 112, and the air bubbles with a heat insulating property may move to periodically change the thermal resistance.

The foregoing embodiments are directed to a power generator 10 mounted on a hybrid car. However, an idea of the present disclosure can also be applied to other types of power generators, for example, stationary power generators.

In the above embodiments and modifications, the casing 11 may correspond to a flow path forming member. The shaft 12 may correspond to a rotation shaft. The heating-side heat switch 14 may correspond to a thermal resistance changing means, a thermal resistance changer, and a heat insulator (first heat insulator). The cooling-side heat switch 14 may correspond to a thermal resistance changing means, a thermal resistance changer, and a heat insulator (second heat insulator). The heating-side annular portions 111a can correspond to a heating section. the cooling-side annular portions 112a can correspond to a cooling section.

According to the present disclosure, a power generator can be provided in various forms.

For example, according to one example, a power generator for taking out electric power from a pyroelectric part by changing temperature of the pyroelectric part exhibiting a pyroelectric effect includes: a heating section that heats the pyroelectric part using a heating medium; a cooling section that cools the pyroelectric part using a cooling medium; and a thermal resistance changer that changes at least one of thermal resistance between the heating medium and the pyroelectric part and thermal resistance between the cooling medium and the pyroelectric part.

According to the above power generator, since at least one of the thermal resistance between the heating medium in the heating section and the pyroelectric part and the thermal resistance between the cooling medium in the cooling section and the pyroelectric part is changed, the temperature of the pyroelectric part can be changed without requiring the pyroelectric part to move back and forth between the heating section and the cooling section. Therefore, it is possible to prevent mixing of the heating medium and the cooling medium.

Specifically, the above power generator may further includes a flow path forming member that defines a heating medium flow path through which the heating medium flows and a cooling medium flow path through which the cooling medium flows. The heating section has a part of the heating medium flow path. The cooling section has a part of the cooling medium flow path. The thermal resistance changer is provided in at least one of the heating medium flow path and the cooling medium flow path.

The thermal resistance changer may include a heat insulator which is movable relative to the pyroelectric part.

The heat insulator may have an electrically insulating property. Because of this, the electric power generated by the pyroelectric part can be prevented from flowing to the heat insulator.

The above power generator may be configured as follows. The flow path forming member includes a partition wall which partitions the heating section and the cooling section. The pyroelectric part has a plate shape and is disposed in the partition wall, so that one plate surface of the pyroelectric part faces onto the heating section and the other plate surface of the pyroelectric part faces onto the cooling section.

The above power generator may be configured as follows. The heat insulator is disposed in a heat-insulator-disposed path, which is one of the heating medium flow path and the cooling medium flow path. The heat insulator is movable by kinetic energy of a heat exchange medium, which is one of the heating medium and the cooling medium that flows through the heat-insulator-disposed path.

According to the above configuration, the heat insulator can be moved by external power as littlie as possible.

The above power generator may be configured as follows. The heat insulator is disposed in a heat-insulator-disposed path, which is one of the heating medium flow path and the cooling medium flow path. The heat insulator is movable by kinetic energy of a heat exchange medium, which is one of the heating medium and the cooling medium that flows through the heat-insulator-disposed path.

The above power generator may further include a rotation shaft linked to the heat insulator. The heat insulator may rotate about the rotation shaft by being subjected to a flow of the heat exchange medium.

The above power generator may be configured as follows. The heat insulator rotates in the heat-insulator-disposed path, which is the one of the heating medium flow path and the cooling medium flow path. The heating medium is introduced in the heat-insulator disposed path from an outer periphery of the heat-insulator disposed path.

According to the above configuration, the heat insulator can be effectively rotated using the kinetic energy of the heat medium.

The above power generator maybe configured as follows. The heat insulator is provided as a first heat insulator disposed in the heating medium flow path and a second heat insulator disposed in the cooling medium flow path. The first heat insulator and the second heat insulator are mechanically linked to the rotation shaft.

According to the above configuration, the heat insulator provided in the heating medium flow path and the heat insulator provided in the cooling medium flow path can be rotated in synchronization.

The above power generator may be configured as follows. The rotation shaft defines a first internal flow path through which the heating medium flows and a second internal flow path through which the cooling medium flows. The first internal flow path and the second internal flow path are formed inside the rotation shaft.

According to the above configuration, the medium flow paths can be formed making effective use of the space in the rotation shaft.

The above power generator may be configured as follows. The rotation shaft has a multiple-layered cylindrical structure, which forms the first internal flow path for conducting the heating medium and the second internal flow path for conducting the cooling medium.

The above power generator may be configured as follows. The heat insulator is provided as a first heat insulator disposed in the heating medium flow path and a second heat insulator disposed in the cooling medium flow path. The first heat insulator and the second heat insulator are moved in synchronization with each other.

The above power generator may be configured as follows. The first heat insulator and the second heat insulator are moved in synchronization with each other while having a phase difference therebetween.

The above power generator may be configured as follows. The first heat insulator and the second heat insulator are moved in synchronization with each other by a magnetic force.

According to the above configuration, as compared with cases where the heat insulator provided in the heating medium flow path and the heat insulator provided in the cooling medium flow path are moved in synchronization using a mechanical linkage, the heating medium and the cooling medium can be securely prevented from mixing.

The above power generator may be configured as follows. The heat insulator has self-oscillation by being subjected to the flow of the heat exchange medium.

The above power generator may further include a guide that confines the self-oscillation of the heat insulator to one-dimensional oscillation in one direction.

According to the above configuration, the self-oscillation direction of the heat insulator can be stabilized.

The above power generator may further include a conversion mechanism that converts the kinetic energy of the heat exchange medium into reciprocating movement of the heat insulator.

The conversion mechanism may include a mechanism for converting the kinetic energy of the heat medium into rotational movement and a mechanism for converting rotational movement into the reciprocating movement.

In the power generator, the heat insulator reciprocatingly moves on a virtual plane parallel to a direction in which the heat exchange medium flows.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A power generator for taking out electric power from a pyroelectric part by changing temperature of the pyroelectric part exhibiting a pyroelectric effect, the power generator comprising:
a heating section that heats the pyroelectric part using a heating medium;
a cooling section that cools the pyroelectric part using a cooling medium; and
a thermal resistance changer that changes at least one of
thermal resistance between the heating medium and the pyroelectric part and
thermal resistance between the cooling medium and the pyroelectric part.

2. The power generator according to claim 1, further comprising
a flow path forming member that defines
a heating medium flow path through which the heating medium flows and
a cooling medium flow path through which the cooling medium flows;
wherein:
the heating section has a part of the heating medium flow path;
the cooling section has a part of the cooling medium flow path; and
the thermal resistance changer is provided in at least one of the heating medium flow path and the cooling medium flow path.

3. The power generator according to claim 2, wherein:
the thermal resistance changer includes a heat insulator which is movable relative to the pyroelectric part.

4. The power generator according to claim 3, wherein:
the heat insulator has an electrically insulating property.

5. The power generator according to claim 3, wherein:
the flow path forming member includes a partition wall which partitions the heating section and the cooling section; and
the pyroelectric part has a plate shape and is disposed in the partition wall, so that one plate surface of the pyroelectric part faces onto the heating section and the other plate surface of the pyroelectric part faces onto the cooling section.

6. The power generator according to claim 3, wherein:
the heat insulator is disposed in a heat-insulator-disposed path, which is one of the heating medium flow path and the cooling medium flow path; and
the heat insulator is movable by kinetic energy of a heat exchange medium, which is one of the heating medium and the cooling medium that flows through the heat-insulator-disposed path.

7. The power generator according to claim 6, further comprising
a rotation shaft linked to the heat insulator,
wherein the heat insulator rotates about the rotation shaft by being subjected to a flow of the heat exchange medium.

8. The power generator according to claim 7, wherein:
the heat insulator rotates in the heat-insulator-disposed path, which is the one of the heating medium flow path and the cooling medium flow path; and
the heating medium is introduced in the heat-insulator disposed path from an outer periphery of the heat-insulator disposed path.

9. The power generator according to claim 8, wherein:
the heating medium is introduced in the heat-insulator-disposed path in a rotation direction of the heat insulator.

10. The power generator according to claim 7, wherein:
the heat insulator is provided as
a first heat insulator disposed in the heating medium flow path and
a second heat insulator disposed in the cooling medium flow path; and
the first heat insulator and the second heat insulator are mechanically linked to the rotation shaft.

11. The power generator according to claim 10, wherein:
the rotation shaft defines a first internal flow path through which the heating medium flows and a second internal flow path through which the cooling medium flows; and
the first internal flow path and the second internal flow path are formed inside the rotation shaft.

12. The power generator according to claim 11, wherein
the rotation shaft has a multiple-layered cylindrical structure, which forms the first internal flow path for conducting the heating medium and the second internal flow path for conducting the cooling medium.

13. The power generator according to claim 3, wherein:
the heat insulator is provided as
a first heat insulator disposed in the heating medium flow path and
a second heat insulator disposed in the cooling medium flow path; and
the first heat insulator and the second heat insulator are moved in synchronization with each other.

14. The power generator according to claim 10, wherein:
the first heat insulator and the second heat insulator are moved in synchronization with each other while having a phase difference therebetween.

15. The power generator according to claim 13, wherein:
the first heat insulator and the second heat insulator are moved in synchronization with each other by a magnetic force.

16. The power generator according to claim 6, wherein
the heat insulator has self-oscillation by being subjected to the flow of the heat exchange medium.

17. The power generator according to claim 16, further comprising
a guide that confines the self-oscillation of the heat insulator to one-dimensional oscillation in one direction.

18. The power generator according to claim 6, further comprising
a conversion mechanism that converts the kinetic energy of the heat exchange medium into reciprocating movement of the heat insulator.

19. The power generator according to claim 18, wherein
the conversion mechanism includes
a mechanism for converting the kinetic energy of the heat medium into rotational movement and
a mechanism for converting rotational movement into the reciprocating movement.

20. The power generator according to claim 18, wherein:
the heat insulator reciprocatingly moves on a virtual plane parallel to a direction in which the heat exchange medium flows.
